(19) United States
(12) Patent Application Publication
(10) Pub. No.: US 2022/0325107 A1
(43) Pub. Date: Oct. 13, 2022

(54) Decorative Film Including Black Layer

(71) Applicant: 3M INNOVATIVE PROPERTIES COMPANY, St. Paul, MN (US)

(72) Inventor: Akihiko Nakayama, Gotemba-city (JP)

(21) Appl. No.: 17/638,333

(22) PCT Filed: Sep. 24, 2020
(86) PCT No.: PCT/IB2020/058941

§ 371 Date: Feb. 25, 2022

(30) Foreign Application Priority Data
Sep. 25, 2019 (JP) 2019-174471

(51) Int. Cl. C09D 5/00; C09D 7/61; C09D 7/41; G02B 5/20

(52) U.S. Cl. CPC C09D 5/00; C09D 7/61; C09D 7/41; G02B 5/208

(57) ABSTRACT

Provided is a decorative film that can reduce temperature increase and exhibit excellent blackness compared to a case where a black layer prepared using a black pigment such as carbon black having a heat ray absorbing capability is employed. A decorative film according to an embodiment of the present disclosure includes a black layer containing a cyan pigment, a magenta pigment, and a yellow pigment, where the decorative film has an average transmittance of approximately 60% or greater for infrared light at a wavelength from 800 to 1800 nm, a light transmittance of approximately 30% or less at a wavelength of 750 nm, and a hue (a*) of approximately 0.80 or less in absolute value and a hue (b*) of approximately 1.2 or less in absolute value.

### TECHNICAL FIELD

The present disclosure relates to a decorative film including a black layer.

### BACKGROUND

In recent years, black paints or black decorative films have been used on, for example, interior materials or exterior materials of automobiles.

Patent Document 1 (JP 3218229 U) discloses a decorative sheet to be mounted on a dashboard of an automobile, the decorative sheet including a low reflection sheet layer in matte black color or matte black-based color, made of suede-like or suede sheets with napped or raised fibers over the surface, a thermal insulation sheet layer provided on the back side of the low reflection sheet layer and made of flexible foamed plastics, and a non-slip sheet layer provided on the back side of the thermal insulation sheet layer and formed with a plurality of protrusions made of silicone resin or polyvinyl chloride resin formed over substantially the entire back surface.

Patent Document 2 (JP 2002-256165 A) discloses a pigment composition that can be used, for example, on an automobile, the pigment composition including a black azo pigment made of a particular chemical formula, where the crystalline form of the black azo pigment is a flaky shape.

### SUMMARY

### Technical Problem

Generally, a black pigment such as carbon black having a heat ray (infrared light) absorbing capability has been used as a black pigment. Such a black pigment tends to absorb heat rays and radiate heat and thus, for example, when the black pigment is used for a roof or an instrument panel of an automobile, which tends to receive direct sunlight during the summer season, such usage may cause the temperature increase inside the automobile.

For example, compositions containing black azo pigments which have a lower heat ray absorbing capability compared to carbon black have been used in paints for temperature increase prevention. However, in addition to the fact that black azo pigments are expensive pigments, since black azo pigments tend to reflect wavelengths in the red region from approximately 700 to approximately 800 nm, it was difficult to develop excellent blackness, such as the one called a pitch black tone.

The present disclosure provides a decorative film that can reduce temperature increase and exhibit excellent blackness compared to a case where a black layer prepared using a black pigment such as carbon black having a heat ray absorbing capability is employed.

### Solution to Problem

An embodiment of the present disclosure provides a decorative film including a black layer, the black layer containing a cyan pigment, a magenta pigment, and a yellow pigment, where the film has an average transmittance of approximately 60% or greater for infrared light at a wavelength from 800 to 1800 nm, a light transmittance of approximately 30% or less at a wavelength of 750 nm, and a hue (a*) of approximately 0.80 or less in absolute value and a hue (b*) of approximately 1.2 or less in absolute value.

Another embodiment of the present disclosure provides an article including a support member and a decorative film including a black layer disposed on the support member, the black layer containing a cyan pigment, a magenta pigment, and a yellow pigment, where a surface of a film side of the article has an average reflectance of approximately 40% or greater for infrared light at a wavelength from 800 to 1800 nm, a light reflectance of approximately 30% or less at a wavelength of 750 nm, and a hue (a*) of approximately 0.80 or less in absolute value and a hue (b*) of approximately 1.2 or less in absolute value.

### Advantageous Effects of Invention

According to the present disclosure, a decorative film that can reduce temperature increase and exhibit excellent blackness compared to the case where a black layer prepared using a black pigment such as carbon black having a heat ray absorbing capability is employed can be provided.

The above description will not be construed to mean that all embodiments of the present invention and all advantages of the present invention are disclosed.

### BRIEF DESCRIPTION OF THE DRAWINGS

FIG. 1 is a cross-sectional view related to a conventional decorative film including a black layer containing a black pigment having a heat ray absorbing capability.

FIG. 2 is a cross-sectional view related to a decorative film according to an embodiment of the present disclosure.

FIG. 3 is a graph related to transmittance of decorative films in Example 1 and Comparative Examples 1 and 2.

FIG. 4 is a graph related to reflectance of a black-painted steel sheet or a white painted steel sheet in Reference Examples 1 and 2.

FIG. 5 is a graph related to reflectance of the samples, in which the decorative films of Example 2 and Comparative Examples 3 and 4 were applied to a white painted steel sheet of Reference Example 2.

FIG. 6 is a graph related to temperature changes when the samples, in which the decorative films of Example 2 and Comparative Example 4 were applied to a white painted steel sheet of Reference Example 2, were placed outdoors.

### DETAILED DESCRIPTION

Although representative embodiments of the present invention will now be described in greater detail for the purpose of illustration with reference to the drawings, the present invention is not limited to these embodiments. As for the reference signs in the drawings, elements denoted by the similar reference signs in different drawings indicate similar or corresponding elements.

In the present disclosure, a “film” also includes an article referred to as a “sheet.” In the present disclosure, for example, the term “on” in the sentence “a surface protection layer disposed on a black layer” is intended to mean that the surface protection layer is disposed directly onto the upper side of the black layer, or the surface protection layer is indirectly disposed above the black layer, with another layer interposed between the surface protection layer and the black layer.

In the present disclosure, for example, the term “under” in the sentence “an adhesive layer disposed under a black layer” is intended to mean that the adhesive layer is disposed directly onto the bottom side of the black layer, or the adhesive layer is indirectly disposed below the black layer, with another layer interposed between the adhesive layer and the black layer.

In the present disclosure, “(meth)acrylic” means acrylic or methacrylic.

In the present disclosure, the term “substantially” refers to including variations caused by for instance manufacturing errors, and is intended to mean that approximately ±20% variation is acceptable.

In the present disclosure, the terms “transparency” or “transmittance” mean that a transmittance of a target light at a particular wavelength or an average transmittance of a target light at a particular wavelength (e.g. visible light, infrared light including near-infrared light) is approximately 60% or greater, approximately 65% or greater, approximately 70% or greater, or approximately 75% or greater. The upper limit of the transmittance or the average transmittance is not particularly limited but, for example, can be approximately less than 100%, approximately 99% or less, or approximately 98% or less.

In the present disclosure, the terms “opaque” or “opaqueness” mean that a transmittance of a target light at a particular wavelength or an average transmittance of a target light at a particular wavelength (e.g. visible light, infrared light including near-infrared light) is approximately 30% or less, approximately 20% or less, or approximately 10% or less. The lower limit of the transmittance or the average transmittance is not particularly limited but, for example, can be approximately 0% or greater, or approximately greater than 0%.

In the present disclosure, the term “reflectance” means that a reflectance of a target light at a particular wavelength or an average reflectance of a target light at a particular wavelength (e.g. visible light, infrared light including near-infrared light) is approximately 40% or greater, approximately 45% or greater, approximately 50% or greater, or approximately 55% or greater. The upper limit of the reflectance or the average reflectance is not particularly limited but, for example, can be approximately less than 100%, approximately 99% or less, or approximately 98% or less.

An example of a decorative film including a black layer is described with reference to the drawings.

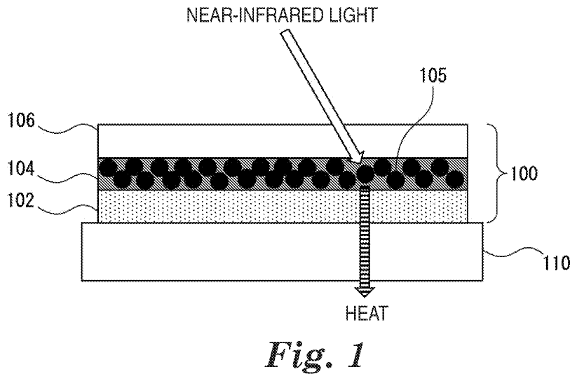

FIG. 1 is a cross-sectional view related to a conventional decorative film 100 including a black layer 104 containing a black pigment 105 having a heat ray absorbing capability. This cross-sectional view assumes a situation where the decorative film is, for example, used on an exterior of a car. The decorative film 100 is disposed on an infrared reflective support member 110 and includes an adhesive layer 102, a black layer 104, and a surface protection layer 106.

In the black layer 104 of the conventional decorative film 100, for example, a black pigment 105 such as carbon black having a heat ray (e.g., near-infrared light) absorbing capability has been used. Thus, the near-infrared light absorbed by the black pigment 105 is converted to heat and radiated into all directions. As illustrated in FIG. 1, a part of the radiated heat is conducted in the downward direction of the support member 110 through the adhesive layer 102 and the support member 110 such as a white painted steel sheet, and thus becomes a cause for the temperature increase inside a car. Note that, in FIG. 1, an arrow of the heat involved in the absorption of near-infrared light is illustrated only in the downward direction in order for the mechanism of the temperature increase in the car to be understood easily; however, in reality, the heat is radiated in all directions in addition to the downward direction. Therefore, in the case where the decorative film is used for the interior, such as an instrument panel, a part of the radiated heat is also conducted in an opposite direction of the heat arrow in FIG. 1 (upward direction), that is, toward the inside of the car. Even in the case where the decorative film is used in such usage, the decorative film still becomes the cause for the temperature increase inside the car.

Meanwhile, since the black layer forming the decorative film of the present disclosure can reduce or prevent the heat ray absorption and the heat radiation effect due to such absorption, the decorative film of the present disclosure can reduce or prevent the temperature increase compared to a case of a decorative film including a black layer prepared using a black pigment such as conventional carbon black.

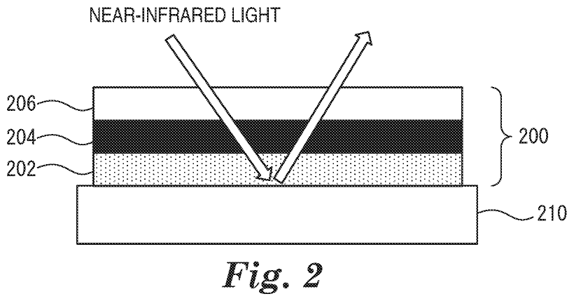

FIG. 2 is a cross-sectional view related to a decorative film 200 according to an embodiment of the present disclosure. Similarly to FIG. 1, the decorative film 200 is disposed on an infrared reflective support member 210 and includes an adhesive layer 202, a black layer 204, and a surface protection layer 206. Note that the adhesive layer 202 and the surface protection layer 206 are optional structural layers, and the decorative film of the present disclosure may contain none of these layers.

The black layer of the present disclosure is a layer prepared by mixing a cyan pigment, a magenta pigment, and a yellow pigment, and thus a large portion of the incident near-infrared light entering into the decorative film 200 is transmitted through the black layer 204, reflected on a surface of the support member 210, and transmitted through the black layer 204 again as illustrated in FIG. 2 unlike the black layer prepared by using a black pigment such as carbon black having a heat ray absorbing capability. That is, compared to the case of a black layer prepared by using a black pigment such as carbon black having a heat ray absorbing capability, the black layer of the present disclosure can reduce or prevent the heat ray absorption and the heat radiation effect due to such absorption and thus, for example, can reduce or prevent the temperature increase inside a car.

Carbon black is commonly known as a pigment that exhibits excellent blackness. Therefore, by using carbon black, a black layer having a color deep enough to be called a tone of pitch black can be prepared relatively easily. However, it has been difficult to prepare such a black layer having a tone of pitch black by using other coloring materials than carbon black. The present inventors found that, when a black layer is prepared using a cyan pigment, a magenta pigment, and a yellow pigment, not only can the black layer exhibit the effects of reduction or prevention of heat ray absorption and heat radiation involving the absorption, but also have excellent deep blackness which is called a tone of pitch black can be produced.

To exemplify representative embodiments of the present disclosure, details of the structural components recited above are described below with some of the reference signs being omitted.

The decorative film of the present disclosure may have a single layer structure including a black layer or a laminate structure having an optional layer described below (e.g., surface protection layer, adhesive layer).

The black layer of the present disclosure contains a cyan pigment, a magenta pigment, and a yellow pigment. These pigments are not particularly limited, and organic pigments and/or inorganic pigments that can develop these colors can be used. Since the black layer of the present disclosure can be prepared using these pigments, not only can the black layer obtained exhibit excellent blackness, but it also enhances weather resistance.

The cyan pigment is not particularly limited as long as it is a pigment that can develop cyan color, and, for example, the following can be used: phthalocyanine pigments such as [chloro-29H,31H-phthalocyaninate(2-)-N29,N30,N31,N32] copper, or organic pigments such as Pigment Blue 15, Pigment Blue 15:1, Pigment Blue 15:2, Pigment Blue 15:3, Pigment Blue 15:4, Pigment Blue 15:6, and Pigment Blue 16; and inorganic pigments such as Pigment Blue 24, Pigment Blue 27 (Prussian blue), Pigment Blue 28 (cobalt blue), Pigment Blue 29 (ultramarine blue), Pigment Blue 33 (manganese blue), Pigment Blue 34, Pigment Blue 35, Pigment Blue 36, Pigment Blue 36:1, Pigment Blue 71, Pigment Blue 72, Pigment Blue 73, Pigment Blue 74 (cobalt blue deep), and Pigment Blue 81. These can be used alone or in combination of two or more thereof. In particular, from the perspectives of weather resistance and pitch blackness, [chloro-29H,31H-phthalocyaninate(2-)-N29,N30,N31,N32] copper is preferred.

The magenta pigment is not particularly limited as long as it is a pigment that can develop magenta color, and, for example, the following can be used: anthracene-based pigments such as 4,4′-diamino-1,1′-bianthracene-9,9′,10,10′-tetraone, or organic pigments such as Pigment Red 122, Pigment Red 178, Pigment Red 179, Pigment Red 202, Pigment Red 254, and Pigment Violet 19; and inorganic pigments such as Pigment Red 101 and 102 can be used. These can be used alone or in combination of two or more thereof. In particular, from the perspectives of weather resistance and pitch blackness, 4,4′-diamino-1,1′-bianthracene-9,9′,10,10′-tetraone is preferred.

The yellow pigment is not particularly limited as long as it is a pigment that can develop yellow color, and, for example, the following can be used: benzimidazolone-based pigments such as N-[(2,3-dihydro-2-oxo-1H-benzimidazol)-5-yl]-3-oxo-2-[[2-(trifluoromethyl)phenyl]azo]butanamide, or organic pigments such as Pigment Yellow 120 and Pigment Yellow 150; and inorganic pigments such as Pigment Yellow 30, 31, 32, 33, 35, 35:1, 36 (zinc yellow), 36:1, 37, 37:1, 41, 42, 43, 44, 45, 47, 53, 118, 119, 129, 157, 158, 159, 160, 161, 162, 163, 164, 184, 189 and 216. These can be used alone or in combination of two or more thereof. In particular, from the perspectives of weather resistance and pitch blackness, N-[(2,3-dihydro-2-oxo-1H-benzimidazol)-5-yl]-3-oxo-2-[[2-(trifluoromethyl)phenyl]azo]butanamide is preferred.

The black layer of the present disclosure may contain a binder resin. The binder resin is not particularly limited, and, for example, (meth)acrylic resins, polyurethane, polyolefin resins, polyester resins, fluororesins, polyvinyl chloride resins, polyamide resins, polystyrene resins, and polycarbonate resins can be used alone or in combination of two or more.

The amount of each of the cyan pigment, the magenta pigment, and the yellow pigment blended in the black layer is not particularly limited, and these pigments may be appropriately blended in such a way that the desired blackness is achieved. To be more specific, these pigments may be appropriately blended in a manner that a decorative film including the black layer, or a surface of the film-side of an article including the decorative film can have a hue (a*) of approximately 0.80 or less in absolute value and a hue (b*) of approximately 1.2 or less in absolute value. Note that the hue (a*), the hue (b*), and lightness (L*) which is described below can be determined in accordance with JIS Z8781-4.

In particular, while a numerical value of a* is an indicator for the red direction (positive value) or the green direction (negative value) of hue, it is conceived that the smaller the numerical value of a* is (i.e. red or green is less visible), the more it looks like a tone of pitch black at least to human eyes. Therefore, the hue (a*) in absolute value of the decorative film including the black layer of the present disclosure or the hue (a*) in absolute value of the surface of the film-side of the article including the decorative film is more preferably approximately 0.60 or less, approximately 0.50 or less, or approximately 0.40 or less from the perspective of a tone of pitch black. The lower limit of these values is not particularly limited but, for example, can be approximately 0 or greater, approximately greater than 0, or approximately 0.10 or greater.

The hue (b*) of the decorative film including the black layer of the present disclosure or the hue (b*) of the article including the decorative film is more preferably approximately 1.1 or less, or approximately 1.0 or less, from the perspective of a tone of pitch black. The lower limit of these values is not particularly limited but, for example, can be approximately 0.40 or greater, approximately 0.50 or greater, or approximately 0.60 or greater.

The lightness (L*) of the decorative film including the black layer of the present disclosure or the lightness (L*) of the article including the decorative film may be, for example, approximately 24.0 or greater, approximately 24.2 or greater, or approximately 24.5 or greater, and may be approximately 25.4 or less, approximately 25.2 or less, or approximately 25.0 or less.

The blackness of the decorative film including the black layer of the present disclosure and the article including the decorative film can be defined by, for example, color difference (ΔE*_{ab}). Note that the “color difference (ΔE*_{ab})” in the present disclosure is in accordance with JIS Z8781-4, and is a value determined based on the following Equation 1 by using two colors (L*₁, a*₁, b*₁) and (L*₂, a*₂, b*₂) of L*a*b* color space:

EQUATION 1

ΔE*_{ab}=\sqrt{(L*₂−L*₁)²+(a*₂−a*₁)²+(b*₂−b*₁)²} Formula 1

Out of these two colors, (L*₁, a*₁, b*₁) corresponds to the reference color for a tone of pitch black, and (L*₂, a*₂, b*₂) corresponds to the color of the decorative film including the black layer or the film-side surface of the article including the decorative film. As a reference color for the tone of pitch black, the black color of a black-painted plate that is prepared by painting KINO-1210 black paint (available from Kansai Paint Co., Ltd.) is used. Note that, in the present disclosure, “black-painted plate” or “black-painted steel sheet” refers to a painted plate or painted steel sheet that exhibits the reference color for the tone of pitch black.

The color difference is one of the indicators defined in between two colors, and the greater the color difference is, the more distinguishable those two colors are, and the smaller the color difference is, the less distinguishable those two colors are. The absolute value of the color difference (ΔE*_{ab}) between the decorative film including the black layer of the present disclosure and the black-painted plate, or the absolute value of the color difference (ΔE*_{ab}) between the article including the decorative film and the black-painted plate may be approximately 1.5 or less, approximately 1.2 or less, approximately 1.0 or less, or approximately 0.80 or less. The lower limit of the absolute value is not particularly limited but, for example, can be approximately 0 or greater, approximately greater than 0, or approximately 0.10 or greater.

The blackness of the decorative film including the black layer of the present disclosure and the article including the decorative film can also be defined by the difference (Δa*) from the reference color of the hue (a*), the difference (Δb*) from the reference color of the hue (b*), and the difference (ΔL*) from the reference color of the lightness (L*).

The absolute value of the difference (Δa*) from the reference color of the hue (a*) may be, for example, approximately 1.0 or less, approximately 0.80 or less, or approximately 0.50 or less, and may be approximately 0 or greater, approximately greater than 0, or approximately 0.10 or greater.

The absolute value of the difference (Δb*) from the reference color of the hue (b*) may be, for example, approximately 1.0 or less, approximately 0.80 or less, or approximately 0.50 or less, and may be approximately 0 or greater, approximately greater than 0, or approximately 0.10 or greater.

The absolute value of the difference (ΔL*) from the reference color of the lightness may be, for example, approximately 1.5 or less, approximately 1.2 or less, or approximately 1.0 or less, and may be approximately 0 or greater, approximately greater than 0, or approximately 0.10 or greater.

In some embodiments, the black layer of the present disclosure may contain a coloring component besides the cyan pigment, the magenta pigment, and the yellow pigment within a range that does not affect the effect of the present disclosure. The amount of such a coloring component that is blended may be, for example, approximately 10 mass % or less, approximately 5 mass % or less, or approximately 1 mass % or less relative to the entire black layer content (solid content). Among coloring components, for the black pigment having a heat ray absorbing capability, such as carbon black, the amount blended may be approximately 0.1 mass % or less, approximately 0.05 mass % or less, or approximately 0.01 mass % or less relative to the entire black layer content (solid content). From the perspectives of blackness and temperature increase resistance, the coloring component, especially the black pigment having a heat ray absorbing capability such as carbon black is not preferably contained.

In some embodiments, the black layer of the present disclosure may contain, as an optional component, for example, a filler, a reinforcing material, an antioxidant, a UV absorber, a light stabilizer, a thermal stabilizer, a dispersant, a plasticizer, a flame retardant, a flow improving agent, a surfactant, a silane coupling agent, a catalyst, and an adhesion-imparting agent, within a range that does not inhibit the effects of the present disclosure.

The thickness of the black layer is not particularly limited and may be, for example, approximately 1 micrometer or greater, approximately 5 micrometers or greater, or approximately 10 micrometers or greater, and may be approximately 200 micrometers or less, approximately 100 micrometers or less, or approximately 50 micrometers or less, from the perspectives of, for example, blackness, followability to a curved surface, and costs.

In the case where the decorative film has a single layer structure including only the black layer, the thickness of the black layer can be defined as an average value calculated by measuring the thickness of freely-selected portion of the film for at least five times by using High-Accuracy Digimatic Micrometer (MDH-25 MB, available from Mitutoyo Corporation). In the case where the decorative film has a laminate structure, for the thickness of the black layer, a cross-section in the thickness direction of the laminate structure is measured by using a scanning electron microscope. And then, an average value of the thicknesses of at least five freely-selected points of the black layer of the laminate structure can be defined as the thickness of the black layer.

Since the decorative film of the present disclosure has a heat ray transmittable black layer, the decorative film including the black layer can achieve an average transmittance of approximately 60% or greater, approximately 65% or greater, or approximately 70% or greater for infrared light (near-infrared light) at a wavelength from 800 to 1800 nm. The upper limit of the average transmittance is not particularly limited and can be, for example, approximately 90% or less, approximately 85% or less, or approximately 80% or less.

Because the black layer of the decorative film of the present disclosure exhibits excellent blackness, the decorative film including the black layer can achieve the light transmittance of approximately 30% or less, approximately 20% or less, approximately 15% or less, approximately 10% or less, approximately 7% or less, or approximately 5% or less at a wavelength of 750 nm. The lower limit of the transmittance is not particularly limited and can be, for example, approximately 0% or greater, greater than approximately 0%, or approximately 1.0% or greater. Since the decorative film of the present disclosure exhibits excellent blackness, the transmittance described above is not only achieved for the light at the wavelength of 750 nm but can be achieved for any light in the entire wavelength region from 400 to 750 nm.

In some embodiments, the decorative film of the present disclosure may further include, as an optional element, an additional layer such as a surface protection layer, a base material layer, a design layer, a bonding layer (also referred to as, for example, “primer layer”) that adheres layers constituting the decorative film, an adhesive layer for adhering the decorative film to an adherend, and a release liner, within a range that does not inhibit the effects of the present disclosure. These additional layers can be employed alone or in combination of two or more. In particular, from the perspectives of protection performances and handleability, at least one selected from a surface protection layer and an adhesive layer is preferably further included.

From the perspectives of followability to a curved surface and costs, the decorative film preferably has no infrared light reflection layer. The decorative film of the present disclosure can be used by being adhered to a support member exhibiting an infrared light reflection capability, such as a white-painted steel sheet, and thus it is not necessary for the decorative film to include an infrared light reflection layer.

From the perspective of temperature increase resistance, the surface protection layer, design layer, base material layer, bonding layer, and adhesive layer are preferably infrared light transmittable.

In the case where the decorative film has a design layer, the design layer is preferably arranged partially on the black layer. In this case, the design layer is preferably a layer that does not have a heat ray absorbing capability and is preferably, for example, a layer colored with a color exhibiting infrared light reflection capability, such as white or silver.

In some embodiments, in the decorative film of the present disclosure, the surface protection layer can be arranged on the black layer, such as on an outermost surface of the decorative film. The surface protection layer may have a substantially flat surface or may have a protruded-recessed form, such as an embossed pattern, on the surface.

As the surface protection layer, for example, various resins including (meth)acrylic resins including polymethyl methacrylate (PMMA), polyurethane, fluororesins such as ethylene/tetrafluoroethylene copolymers (ETFE), polyvinylidene fluoride (PVDF), and methyl methacrylate/vinylidene fluoride copolymers, silicone-based copolymers, polyvinyl chloride, polycarbonate, acrylonitrile-butadiene-styrene copolymers (ABS), polyolefin such as polyethylene and polypropylene, polyester such as polyethylene terephthalate (PET) and polyethylene naphthalate (PEN), copolymers such as ethylene/acrylic acid copolymers, ethylene/ethyl acrylate copolymers, and ethylene/vinyl acetate copolymers and mixtures of these can be used. From the perspectives of transparency, strength, and impact resistance, as the surface protection layer, a (meth)acrylic resin, polyurethane, a fluororesin, polyvinyl chloride, polyethylene terephthalate, an acrylonitrile-butadiene-styrene copolymer, and polycarbonate can be advantageously used. The surface protection layer may function as a protection layer that protects the other layers constituting the decorative film from, for example, needling and impact applied from outside. The surface protection layer may be a multilayered laminate, such as a multilayered extrusion laminate.

The surface protection layer may contain benzotriazole, a UV absorber such as Tinuvin (trademark) 400 (available from BASF), or a hindered amine light stabilizer (HALS) such as Tinuvin (trademark) 292 (available from BASF), as necessary. By using, for example, a UV absorber or a hindered amine light stabilizer, deterioration of a layer positioned under the surface protection layer, such as color change, fading, and deterioration of the black layer, can be effectively prevented. The surface protection layer may contain, for example, a hard coat material and a gloss-imparting agent, and may have an additional hard coat layer.

The surface protection layer is typically entirely transparent in the visible range (wavelength of 400 nm or greater but less than 800 nm) and the near-infrared range (wavelength of 800 nm or greater but 1800 nm or less); however, in order to provide a target appearance (e.g. matte appearance), the surface protection layer may be entirely or partially semi-transparent in the visible range or partially opaque in the visible range. In some embodiments, the total light transmittance in the visible range of the surface protection layer measured in accordance with JIS K 7375 is approximately 85% or greater, approximately 90% or greater, or approximately 95% or greater.

The thickness of the surface protection layer may be, for example, approximately 1 micrometer or greater, approximately 5 micrometers or greater, or approximately 10 micrometers or greater, and may be approximately 200 micrometers or less, approximately 100 micrometers or less, or approximately 50 micrometers or less. For the thickness of the surface protection layer constituting the decorative film, the cross-section in the thickness direction of the decorative film of the laminate structure is measured by using a scanning electron microscope. And then, an average value of the thicknesses of at least five freely-selected points of the surface protection layer of the laminate structure can be defined as the thickness of the surface protection layer.

In some embodiments, the decorative film of the present disclosure may contain a base material. The base material can be used as, for example, a support of the black layer.

Examples of raw materials for the base material include polyvinyl chloride resins, polyurethane resins, polyolefin resins, polyester resins, polycarbonate resins, polyimide resins, polyamide resins, (meth)acrylic resins, and fluororesins. These may be used alone or in combination of two or more of them. In particular, a polyurethane resin is preferable from a perspective of chipping resistance.

The thickness of the base material is not particularly limited and may be, for example, approximately 50 micrometers or greater, approximately 80 micrometers or greater, or approximately 100 micrometers or greater. The upper limit of the thickness is not particularly limited but can be, for example, approximately 500 micrometers or less, approximately 300 micrometers or less, or approximately 200 micrometer or less, from the perspectives of followability and production cost, for example. For the thickness of the base material constituting the decorative film, the cross-section in the thickness direction of the decorative film of the laminate structure is measured by using a scanning electron microscope. And then, an average value of the thicknesses of at least five freely-selected points of the base material of the laminate structure can be defined as the thickness of the base material.

The base material may contain, as an optional component, for example, a filler, a reinforcing material, an antioxidant, a UV absorber, a light stabilizer, a thermal stabilizer, a dispersant, a plasticizer, a flow improving agent, a surfactant, a leveling agent, a silane coupling agent, and a catalyst, within the range that does not inhibit the effects of the present disclosure.

In some embodiments, the decorative film of the present disclosure may have a bonding layer to bond the layers constituting the decorative film. As the bonding layer, for example, a commonly used (meth)acrylic-based, polyolefin-based, polyurethane-based, polyester-based, or rubber-based solvent type, emulsion type, pressure sensitive type, heat sensitive type, thermosetting type, or UV curing type adhesive can be used. The bonding layer can be applied by a known coating method or the like.

The thickness of the bonding layer may be, for example, approximately 0.05 micrometers or greater, approximately 0.5 micrometers or greater, or approximately 5 micrometers or greater, and may be approximately 100 micrometers or less, approximately 50 micrometers or less, approximately 20 micrometers or less, or approximately 10 micrometers or less. For the thickness of the bonding layer constituting the decorative film, the cross-section in the thickness direction of the decorative film of the laminate structure is measured by using a scanning electron microscope. Then, an average value of the thicknesses of at least five freely-selected points of the bonding layer of the laminate structure can be defined as the thickness of the bonding layer.

In some embodiments, the decorative film of the present disclosure may further have an adhesive layer to adhere the decorative film to an adherend. As for the raw materials of the adhesive layer, ones that are the same as the raw materials for the bonding layer can be used. The adhesive layer may be applied not to the decorative film but to an adherend.

The thickness of the adhesive layer may be, for example, approximately 5 micrometers or greater, approximately 10 micrometers or greater, or approximately 20 micrometers or greater, and may be approximately 200 micrometers or less, approximately 100 micrometers or less, or approximately 80 micrometers or less. For the thickness of the adhesive layer constituting the decorative film, the cross-section in the thickness direction of the decorative film of the laminate structure is measured by using a scanning electron microscope. Then, an average value of the thicknesses of at least five freely-selected points of the adhesive layer of the laminate structure can be defined as the thickness of the adhesive layer.

The bonding layer and the adhesive layer may contain, as an optional component, for example, an antioxidant, a UV absorber, a light stabilizer, a thermal stabilizer, an adhesion-imparting agent, a dispersant, a plasticizer, a flow improving agent, a surfactant, a leveling agent, a silane coupling agent, and a catalyst, within the range that does not inhibit the effect and the decorativeness of the present disclosure.

Any suitable release liner can be used to protect the adhesive layer. Examples of a typical release liner include those prepared from paper (e.g., kraft paper), and from polymeric materials (e.g., polyolefin such as polyethylene or polypropylene, ethylene vinyl acetate, polyurethane, polyethylene terephthalate, and other such polyester). On the release liner, a layer of a release agent such as a silicone-containing material or a fluorocarbon-containing material may be applied as necessary.

The thickness of the release liner may be, for example, approximately 5 micrometers or greater, approximately 15 micrometers or greater, or approximately 25 micrometers or greater, and may be approximately 300 micrometers or less, approximately 200 micrometers or less, or approximately 150 micrometers or less. The thickness of the release liner can be defined as an average value calculated by, after the release liner is removed from the decorative film, measuring the thickness of freely-selected portion of the release liner for at least five times by using High-Accuracy Digimatic Micrometer (MDH-25 MB, available from Mitutoyo Corporation).

The decorative film of the present disclosure can be appropriately prepared by a single or a combination of a plurality of publicly known methods, such as printing methods including gravure direct printing, gravure offset printing, inkjet printing, and screen printing, coating methods such as gravure coating, roll coating, die coating, bar coating, and knife coating, extrusion methods, lamination methods, and transfer methods.

As an example, the following production method is described below; however, the production method of the decorative film is not limited to this. For example, in the case of the decorative film having the structure illustrated in FIG. 2, a black coating composition prepared by appropriately mixing the binder resin described above and various pigments, and optionally a solvent and the optional components described above is coated on a surface protection film formed by, for example, an extrusion method, and then, as necessary, a drying process and a curing process are applied, to prepare a laminate A including a black layer. Next, on a commercially available release liner, an adhesive is coated and then, as necessary, a drying process and a curing process are applied, to prepare a laminate B. A decorative film can be formed by adhering the black layer of the laminate A with the adhesive layer of the laminate B.

Alternatively, an adhesive is coated on a base material and then, as necessary, a drying process and a curing process are applied. Thereafter, a release liner is adhered to the adhesive layer to prepare a laminate a. On the surface of a base material of the laminate a, the black coating composition describe above can be coated and then, as necessary, a drying process and a curing process can be applied to prepare a black layer. Thereafter, a surface protection layer can be applied to the black layer by coating or an extrusion method, or a surface protection film is adhered to the black layer so as to form a decorative film.

The binder resin that can be used in the black coating composition is not limited to the binder resin described above and may be a monofunctional or multifunctional monomer and/or oligomer that can constitute the binder resin described above. In the black coating composition, for example, polymerization initiators, crosslinking agents, curing agents, curing accelerators, and solvents (e.g. water-based solvents, organic solvents) can be appropriately blended in addition to the optional component described above, as necessary.

The decorative film of the present disclosure can be suitably used for decorating a component that is exposed to sunbeam. Examples of the article including the decorative film of the present disclosure include interior or exterior components for decoration, such as interior or exterior components of vehicles including cars, trains, aircraft, and ships (e.g., roof components, pillar components, door trim components, instrument panel components, front components such as hood, bumper components, fender components, and side sill components), and building components (e.g., window glass, doors, window frames, roof component such as tiles, and outer wall components).

In some embodiments, the decorative film of the present disclosure can be applied for a support member having an infrared light reflection capability. With such a configuration, an infrared light reflection layer that has poor followability to a curved surface and that may reduce an infrared light reflection capability can be omitted, and thus such a configuration can reduce or prevent reduction of temperature increase resistance and increase in cost.

The support member exhibiting such an infrared light reflection capability is not particularly limited and, for example, a support member having an average reflectance of approximately 50% or greater, approximately 60% or greater, or approximately 70% or greater for infrared light at a wavelength from 800 to 1800 nm can be employed. The upper limit of the average reflectance is not particularly limited and can be, for example, approximately 100% or less, approximately less than 100%, or approximately 99% or less. The infrared light reflection capability of the support member has only to be achieved at least at the part where the decorative film is applied, and may be achieved for the entire support member.

As the infrared reflective support member, for example, an existing structure, such as an interior component or exterior component of a vehicle painted with white or silver or a heat ray reflective glass that is employed in, for example, a building, can be employed. The decorative film of the present disclosure can contribute to the reduction of cost increase because less defects, such as coating unevenness, occur compared to black coating applied by the means such as spray coating, which requires the mastery of skills, and the excellent black appearance can be easily achieved, as an existing structure described above in a vehicle or building can be used as is.

For the article including the decorative film of the present disclosure, a surface of the decorative film side of the article can have the average reflectance of approximately 40% or greater for infrared light at a wavelength from 800 to 1800 nm, the light reflectance of approximately 30% or less at a wavelength of 750 nm, and the hue (a*) of approximately 0.80 or less in absolute value and the hue (b*) of approximately 1.2 or less in absolute value. Note that the numerical ranges of, for example, the hue (a*) and the hue (b*), the lightness (L*), and the color difference (ΔE*_{ab}) of the surface of the decorative film side of the article are as described above.

For the article including the decorative film of the present disclosure, the surface of the decorative film side of the article can achieve the average reflectance of approximately 40% or greater, approximately 45% or greater, approximately 50% or greater, approximately 55% or greater, or approximately 60% or greater for infrared light at a wavelength from 800 to 1800 nm. The upper limit of the average reflectance is not particularly limited and can be, for example, approximately 90% or less, approximately 85% or less, or approximately 80% or less. Note that, for the article including the decorative film of the present disclosure, its average reflectance for infrared light at a wavelength from 800 to 1800 nm does not exceed the average reflectance of the surface of the support member to which the film is to be applied for infrared light in the same wavelength range.

For the article including the decorative film of the present disclosure, the surface of the decorative film side of the article can achieve the light reflectance of approximately 30% or less, approximately 20% or less, approximately 15% or less, approximately 10% or less, or approximately 8% or less at a wavelength of 750 nm. The lower limit of the reflectance is not particularly limited and can be, for example, approximately 0% or greater, greater than approximately 0%, or approximately 1.0% or greater. Since the decorative film of the present disclosure exhibits excellent blackness, the reflectance described above is not only achieved for the light at the wavelength of 750 nm but can be achieved for any light in the entire wavelength region from 400 to 750 nm.

The method of applying the decorative film of the present disclosure to a support member (adherend) constituting the article is not particularly limited, and a known method can be suitably used. Examples of such a method include injection molding methods, such as an insert injection molding method, in-mold molding method, over-mold molding method, two color injection molding method, core-back injection molding method, and sandwich injection molding method, lamination methods, and 3D heat expansion molding method (TOM).

### EXAMPLES

Specific embodiments of the present disclosure will be exemplified in the following examples, but the present invention is not limited to these embodiments. All parts and percentages are based on mass unless otherwise specified.

Products and the like used in the examples are shown in Table 1 below.

TABLE 1

| Product name or abbreviation | Description | Source of supply |
|---|---|---|
| Cyan pigment | [Chloro-29H,31H-phthalocyaninate(2-)- | Sanyo Color Works, Ltd. |
| | N29,N30,N31,N32] steel | (Himeji-shi, Hyogo, Japan) |
| Magenta pigment | 4,4′-diamino-1,1′-bianthracene- | DIC Corporation |
| | 9,9′,10,10′-tetraone | (Itabashi-ku, Tokyo, Japan) |
| Yellow pigment | N-[(2,3-dihydro-2-oxo-1H-benzimidazol)-5- | Clariant AG |
| | yl]-3-oxo-2-[[2- | (Muttenz, Switzerland) |
| | (trifluoromethyl)phenyl]azo]butanamide | |
| CHROMOFINE BLACK | 1-{4-[(4,5,6,7-tetrachloro-3-oxoisoindolin-1- | Dainichiseika Color & |
| (trademark) A1103 | ylidene)amino]phenylazo}-2-hydroxy-N-(4′- | Chemicals Mfg. Co., Ltd. |
| | methoxy-2′-methylphenyl)-l 1H- | (Chuo-ku, Tokyo, Japan) |
| | benzo[a]carbazole-3-carboxamide | |
| MONARCH (trademark) 1400 | Carbon black | CABOT (Boston, Massachusetts, USA) |
| Binder resin | Polycarbonate | 3M Japan Ltd. |
| | urethane resin | (Shinagawa-ku, Tokyo, Japan) |
| MEK | Methyl | Idemitsu Kosan Co., Ltd. |
| | ethyl ketone | (Chiyoda-ku, Tokyo, Japan) |
| 3M (trademark) Scotchcal | Adhesive film including acrylic pressure- | 3M Japan Ltd. |
| (trademark) FPU3000J | sensitive adhesive layer and | (Shinagawa-ku, |
| | polyurethane base material film | Tokyo, Japan) |
| KINO-1210 Black | Acrylic resin-based solvent-type top coating | Kansai Paint Co., Ltd. |
| | black paint (containing carbon black) | (Chuo-ku, Osaka-shi, Japan) |
| 01820 White | Acrylic resin-based solvent-type | Nippon Paint Co., Ltd. |
| | top coating white paint | (Shinagawa-ku, Tokyo, Japan) |
| AMILAC WHITE | Aminoalkyd resin white paint | Kansai Paint Co., Ltd. |
| | | (Chuo-ku, Osaka-shi, Japan) |

The materials shown in Table 1 were mixed at blending proportions shown in Table 2 to prepare each black coating composition for black layer preparation. The numerical values in Table 2 are all in units of parts by mass.

TABLE 2

| | Black coating composition | | |
|---|---|---|---|
| | 1 | 2 | 3 |
| Cyan pigment | 15.48 | — | — |
| Magenta pigment | 16.13 | — | — |
| Yellow pigment | 5.15 | — | — |
| CHROMOFINE BLACK (trademark) A1103 | — | 5.2 | — |
| MONARCH (trademark) 1400 | — | — | 8.2 |
| Binder resin | 63.25 | 94.8 | 91.8 |
| MEK | 30 | 30 | 30 |
| Total | 130 | 130 | 130 |

Evaluation of the decorative films of Example 1 and Comparative Examples 1 and 2 were performed.

### Example 1

The black coating composition 1 was coated on a polyurethane base material film face of 3M (trademark) Scotchcal (trademark) FPU3000J film by using a knife coater and dried to prepare a decorative film including a black layer having a thickness of approximately 25 micrometers.

### Comparative Example 1

A decorative film including a black layer having a thickness of approximately 25 micrometers was prepared in the same manner as in Example 1 except for using the black coating composition 2 instead of the black coating composition 1.

### Comparative Example 2

A decorative film including a black layer having a thickness of approximately 25 micrometers was prepared in the same manner as in Example 1 except for using the black coating composition 3 instead of the black coating composition 1.

### Physical Property Evaluation Test 1

Properties of the decorative film were evaluated by using the following methods.

### Transmittance Test

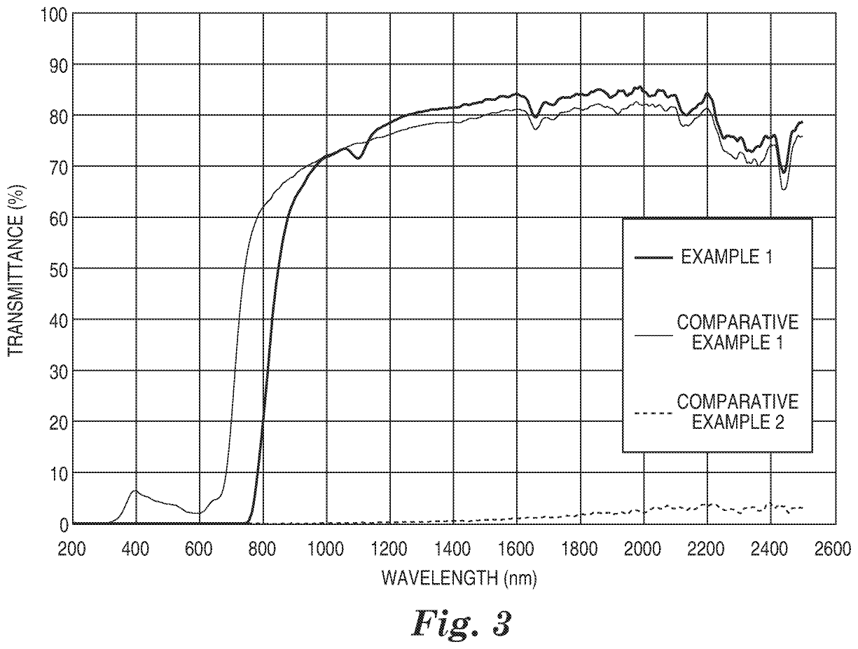

The transmittance of each of the decorative films was measured by using U-4100 Spectrophotometer available from Hitachi High-Tech Corporation in accordance with JIS K 7375. The results are shown in FIG. 3 and Table 3. The measurement wavelength was in a range from 200 to 2500 nm.

TABLE 3

| | | Comparative | Comparative |
|---|---|---|---|
| | Example 1 | Example 1 | Example 2 |
| Average transmittance at 800 to 1800 nm (%) | 76 | 76 | 0.5 |
| Transmittance at 750 nm (%) | 0.2 | 53 | 0 |

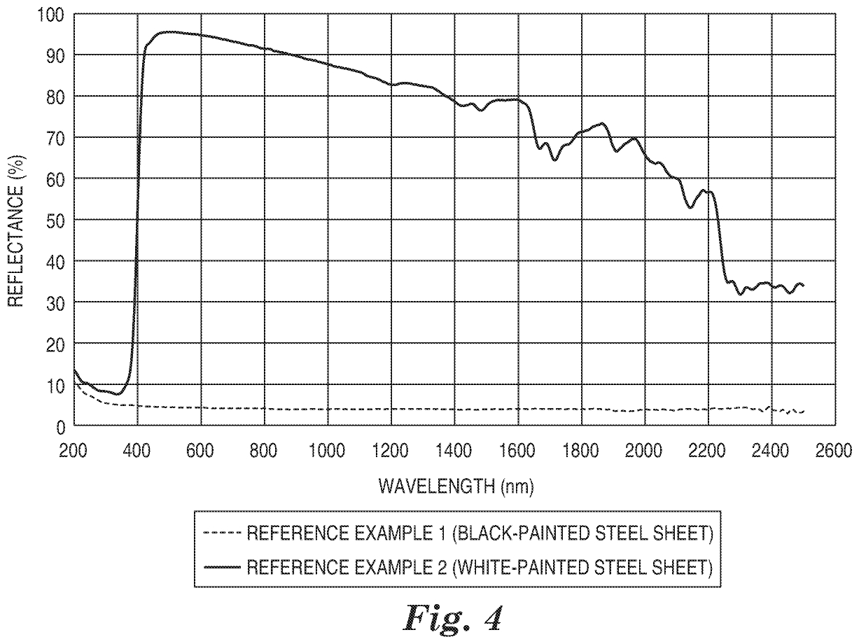

Evaluation was then performed for the article prepared by applying each of the decorative films of Example 1 and Comparative Examples 1 and 2 to the infrared reflective support member. Note that, as Reference Examples, evaluation of reflectance for each of the support members was performed. The results are shown in FIG. 4 and Table 4.

### Reference Example 1

A black-painted steel sheet, which served as a reference of, for example, color difference (ΔE*_{ab}) described below, was prepared by spray-coating KINO-1210 black paint to one side of a steel sheet (length: 150 mm; width: 70 mm; thickness: 0.8 mm).

### Reference Example 2

A white-painted steel sheet was prepared by spray-coating AMILAC WHITE twice to one face of a steel sheet (length: 150 mm; width: 70 mm; thickness: 0.8 mm).

### Example 2

An article was prepared by using the white-painted steel sheet of Reference Example 2 as a support member, and by adhering the decorative film prepared by Example 1 to a white-painted face of the white-painted steel sheet, with a pressure-sensitive adhesive layer interposed between the decorative film and the white painted steel sheet.

### Comparative Example 3

An article was prepared in the same manner as in Example 2 except for using the decorative film of Comparative Example 1.

### Comparative Example 4

An article was prepared in the same manner as in Example 2 except for using the decorative film of Comparative Example 2.

### Physical Property Evaluation Test 2

Properties of each of the articles were evaluated by using the following methods.

### Reflectance Test

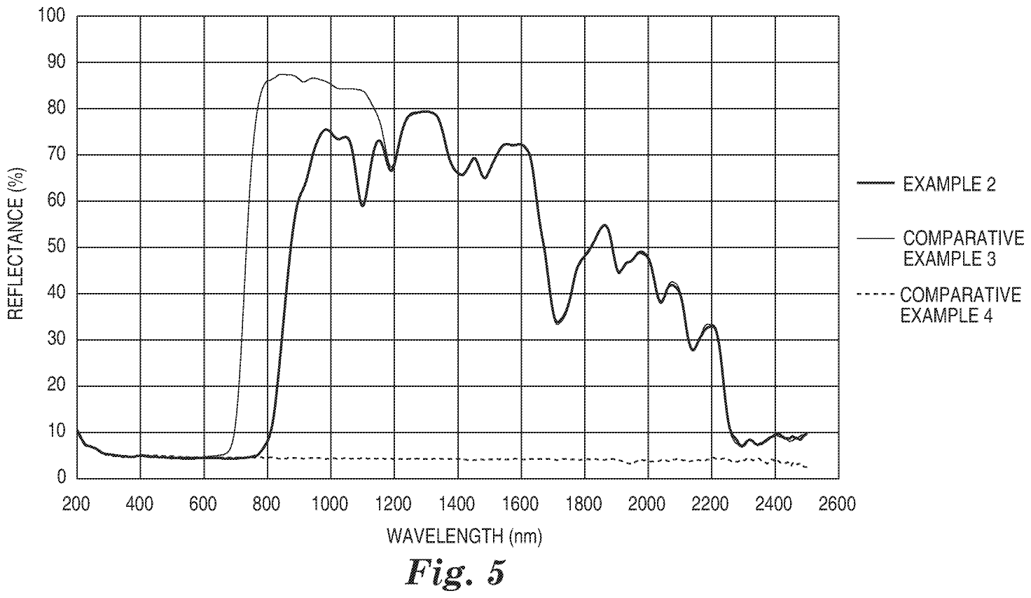

The reflectance of the decorative film side of the article was measured by using U-4100 Spectrophotometer, available from Hitachi High-Tech Corporation, in accordance with JIS K 7375. The results are shown in FIG. 5 and Table 4. The measurement wavelength was in a range from 200 to 2500 nm.

### Hue Test

The hue (a*, b*) and the lightness (L*) of the decorative film side of the article were measured by using Datacolor 600, available from Sun Color K.K., in accordance with JIS Z8781-4. The results are shown in Table 4. Note that the hue and the lightness of the decorative film side of the article are substantially the same as the hue and the lightness measured by using the decorative film alone. Therefore, the values of the hue and the like obtained by this method can be taken as the values of the hue and the like of the decorative film alone.

The color difference (ΔE*_{ab}) in Table 4 is intended for the color difference from the black-painted steel sheet of Reference Example 1 and is a value calculated by the following equation:

EQUATION 2

ΔE*_{ab}=\sqrt{(L*₂−L*₁)²+(a*₂−a*₁)²+(b*₂−b*₁)²} Formula 1

where, L*₁, a*₁, and b*₁ in the equation are the numerical values of the hue and the lightness of the black-painted steel sheet of Reference Example 1, and L*₂, a*₂, and b*₂ are the numerical values of the hue and the lightness of the side of the decorative film applied to each of the articles.

### Insolation Test

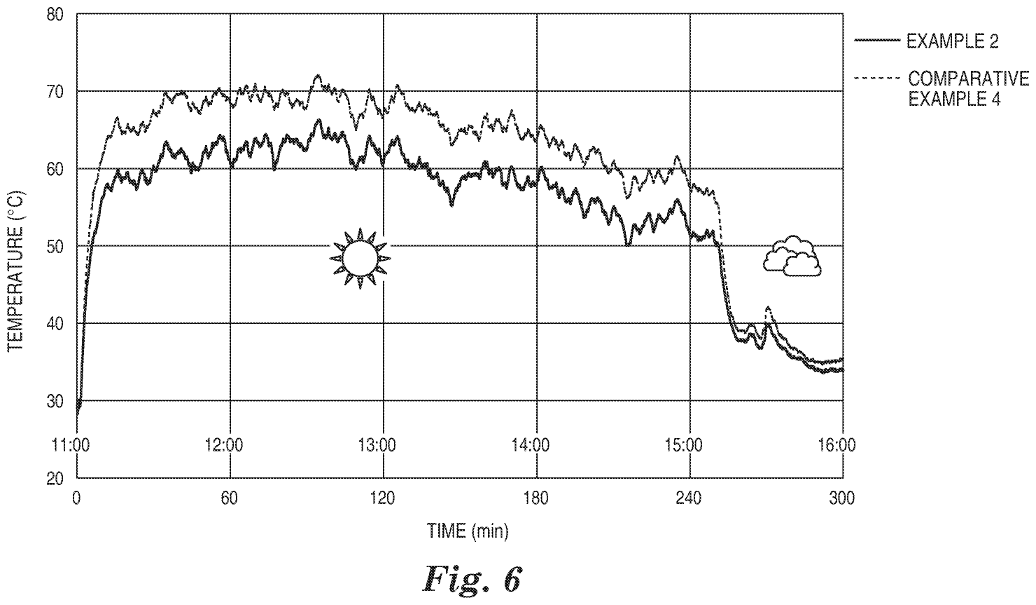

For the face (steel sheet face) opposite from the decorative film applied face of the article, a thermocouple mounted on a thermometer (MEMORY HiLOGGER 8421, available from Hioki E.E. Corporation) was applied, and felt (NFBC5, available from Nippon Felt Co., Ltd.) was adhered to the steel sheet face in a manner that the thermocouple was covered so as to prepare a test sample. This test sample was left on a roof of a laboratory in Sagamihara Site of 3M Japan Ltd. (Sagamihara-shi, Kanagawa-ken, Japan) from 11 a.m. to 4 p.m. in a manner that the decorative film face was exposed to sunlight to measure the temperature change of the test sample. The result is shown in FIG. 6. This test was performed on Jul. 10, 2018, and it was sunny around 11 a.m. to 3 p.m. but was cloudy around 3 p.m. to 4 p.m.

Note that insolation test can be also performed by using artificial solar lighting (XC-500EF, available from Seric Ltd.). In this case, the temperature difference that was approximately double the temperature difference of this test result was achieved. That is, the article of Example 2 resulted in exhibiting a temperature that was, at maximum, approximately 20° C. lower than the temperature of the article of Comparative Example 4.

TABLE 4

| | | | | | Reference | |
|---|---|---|---|---|---|---|
| | | Example | Comparative | Comparative | Example 1 | Reference |
| | | 2 | Example 3 | Example 4 | (Reference) | Example 2 |
| Reflectance | Average reflectance | 63 | 72 | 4.3 | 3.9 | 81 |
| test | at 800 to 1800 nm (%) | | | | | |
| | Reflectance at 750 | 4.8 | 68 | 4.6 | 4.2 | 92 |
| | nm (%) | | | | | |
| Hue test | Hue (a*) | 0.32 | 1.0 | −0.32 | −0.05 | — |
| | Hue (b*) | −0.96 | −0.37 | −0.95 | −0.76 | — |
| | Lightness (L*) | 24.7 | 25.4 | 25.7 | 24.2 | — |
| | Color difference | 0.66 | 1.7 | 1.6 | — | — |
| | (ΔE*_{ab}) | | | | | |

It will be apparent to those skilled in the art that various modifications can be made to the embodiments and the examples described above without departing from the basic principles of the present invention. In addition, it will be apparent to those skilled in the art that various improvements and modifications of the present invention can be carried out without departing from the spirit and the scope of the present invention.

### REFERENCE SIGNS LIST

100, 200 Decorative film
102, 202 Adhesive layer
104, 204 Black layer
105 Black pigment having a heat ray absorbing capability
106, 206 Surface protection layer
110, 210 Infrared reflective support member

1. A decorative film comprising a black layer,
the black layer containing a cyan pigment, a magenta pigment, and a yellow pigment, wherein
the film has an average transmittance of 60% or greater for infrared light at a wavelength from 800 to 1800 nm,
the film has a light transmittance of 30% or less at a wavelength of 750 nm, and
the film has a hue (a*) of 0.80 or less in absolute value and a hue (b*) of 1.2 or less in absolute value.

2. The film according to claim 1, wherein a color difference between the film and a black-painted plate (ΔE*_{ab}) is 1.5 or less in absolute value.

3. The film according to claim 1, wherein an amount of a coloring component blended in the black layer except the cyan pigment, the magenta pigment, and the yellow pigment is 10 mass % or less.

4. The film according to claim 1, wherein an amount of carbon black blended in the black layer is 0.1 mass % or less.

5. The film according to claim 1, further comprising at least one selected from a surface protection layer and an adhesive layer.

6. The film according to claim 1, wherein the film is applied to an interior or exterior of a vehicle.

7. The film according to claim 1, wherein the film is applied to a support member having an average reflectance of 50% or greater for infrared light at a wavelength from 800 to 1800 nm.

8. An article comprising a support member and a decorative film including a black layer disposed on the support member,
the black layer containing a cyan pigment, a magenta pigment, and a yellow pigment, wherein
a surface of a film side of the article has an average reflectance of 40% or greater for infrared light at a wavelength from 800 to 1800 nm,
the surface of the film side of the article has a light reflectance of 30% or less at a wavelength of 750 nm, and
the surface of the film side on the article has a hue (a*) of 0.80 or less in absolute value and a hue (b*) of 1.2 or less in absolute value.

9. The article according to claim 8, wherein a color difference (ΔE*_{ab}) between the surface of the film side on the article and a black-painted plate is 1.5 or less in absolute value.

10. The article according to claim 8, wherein an amount of a coloring component blended in the black layer except the cyan pigment, the magenta pigment, and the yellow pigment is 10 mass % or less.

11. The article according to claim 8, wherein an amount of carbon black blended in the black layer is 0.1 mass % or less.

12. The article according to claim 8, wherein the film further includes at least one selected from a surface protection layer and an adhesive layer.

13. The article according to claim 8, wherein the article is an interior or exterior of a vehicle.

14. The article according to claim 8, wherein a surface of a part of the support member to which the film is to be applied has an average reflectance of 50% or greater for infrared light at a wavelength from 800 to 1800 nm.
